(19) United States
(12) Patent Application Publication
(10) Pub. No.: US 2009/0236877 A1
(43) Pub. Date: Sep. 24, 2009

(54) Vehicle Frame Assembly And Method Having Flexible Modular Architecture

(75) Inventors: Len V. Peschansky, West Bloomfield, MI (US); David L. Von Knorring, Oxford, MI (US); Robert F. Norton, Lake Orion, MI (US); Frank Burger, Ortonville, MI (US); Timothy J. Herrick, Rochester Hills, MI (US); Richard E. Jayroe, Rochester Hills, MI (US)

Correspondence Address: Quinn Law Group, PLLC, 39555 Orchard Hill Place, Suite 520, Novi, MI, 48375, US

(73) Assignee: GM Global Technology Operations, Inc., Detroit, MI (US)

(21) Appl. No.: 12/051,357

(22) Filed: Mar. 19, 2008

(51) Int. Cl. B62D 21/14

(52) U.S. Cl. 296/203.01

(57) ABSTRACT

A method of constructing vehicle frames of varying lengths from a flexible modular architecture is provided. The method comprises: providing substantially identical front and rear modules, and providing middle modules with constant-section longitudinal rails that are formable to a variety of desired lengths. The components are selected by trimming or forming a first middle module to a first longitudinal length and selecting one each of the substantially identical front and rear modules. A first frame, having a first frame length, is then assembled from the formed first middle module and substantially identical front and rear modules. After forming another middle module to a second length; a second frame, having a different frame length, may then be assembled from the second formed middle module and a second pair of substantially identical front and rear modules. An assembly for constructing frames of varying lengths from a flexible modular architecture is also provided.

### TECHNICAL FIELD

This disclosure relates to body-on-frame automobile construction. Specifically, a unique flexible architecture for, and method of, assembling frames for a wide variety of body-on-frame vehicles from shared modules.

### BACKGROUND OF THE INVENTION

Body-on-frame is an automotive industry manufacturing methodology whereby a separate body is mounted to a rigid frame which supports the body, drivetrain, and suspension. As opposed to body-integrated-frame or monocoque construction, body-on-frame remains the preferred construction method for heavier-duty vehicles, especially those which are intended to carry and pull loads, such as trucks and pickup trucks, and those which are off-road capable, such as sport-utility vehicles.

Body-on-frame automobiles have previously required distinct frames for each vehicle size, wheelbase variation, and body style. This, in turn, requires that distinct engineering and manufacturing design solutions be created for each vehicle size, wheelbase variation, and body style. For example, an automotive manufacturer may have a small sport-utility vehicle with a wheelbase of 2870 millimeters (113 inches), a mid-size sport-utility vehicle with a wheelbase of 2945 millimeters (116 inches), and small pickup truck with a wheelbase of 2820 millimeters (111 inches); and each of these, otherwise similarly-sized, vehicles would require a distinct frame created from distinct frame components. Creating distinct frame components incurs substantial design and production costs for proofing, tooling, and testing of manufacturing processes used to produce the final frame.

### SUMMARY OF THE INVENTION

A unique assembly and method having flexible modular architecture for body-on-frame vehicle construction is provided by replacing distinct frame components with commonly-shared, substantially-identical frame modules. Previously unknown flexibility in body-on-frame construction is provided, allowing commonality of frame modules used in assembly of frames for multiple vehicle platforms. With this new modular body-on-frame architecture, substantially-identical frame modules are used to create frames with different sizes, wheelbases and configurations. Furthermore, this truly modular body-on-frame architecture also allows extensive part-sharing schemes across multiple vehicle model lines and platforms. Using the method of assembling vehicle frames from this unique modular body-on-frame architecture, a vehicle manufacturer may improve the time and cost efficiency of manufacturing and assembling frames for diverse vehicle platforms.

A method of assembling vehicle frames from a flexible modular architecture is provided. The method comprises first providing substantially identical front and substantially identical rear modules, and providing middle modules with constant-section longitudinal rails that are formable to a variety of desired lengths. The components are assembled by first trimming or forming a first middle module to a first longitudinal length and selecting one each of the substantially identical front and rear modules. A first frame, having a first frame length, is then assembled from the formed first middle module and substantially identical front and rear modules. After forming another middle module to a second length; a second frame, having a second frame length different from the first, may then be assembled from the second formed middle module and a second pair of substantially identical front and rear modules.

An assembly having flexible modular architecture is also provided. Substantially identical front and rear frame modules of predetermined, fixed lengths form the common base for all assembled vehicle frames. By mating these substantially identical front and rear modules to a mid frame module having parallel longitudinal members that can be easily formed to myriad lengths and have a constant cross section, the assembly is capable of producing vehicle frames of variable lengths from largely fixed-length components. The front and rear structural frame attachment interfaces which facilitate mating of the components are capable of mating to the formable mid frame module, regardless of the length to which it is trimmed or formed.

### BRIEF DESCRIPTION OF THE DRAWINGS

FIG. 1 is an elevated view of an embodiment of a modular body-on-frame architecture, including front, middle and rear modules;

FIG. 2 is a front view of the middle module of FIG. 1;

FIG. 3 is a side view of multiple frames assembled from the modular body-on-frame architecture of FIG. 1;

FIG. 4 is an elevated view of an embodiment of a modular body-on-frame architecture having two rear modules; and

FIG. 5 is a side view of two rear pickup modules, having modular bracket sets attached in first and second configurations.

### DESCRIPTION OF THE PREFERRED EMBODIMENTS

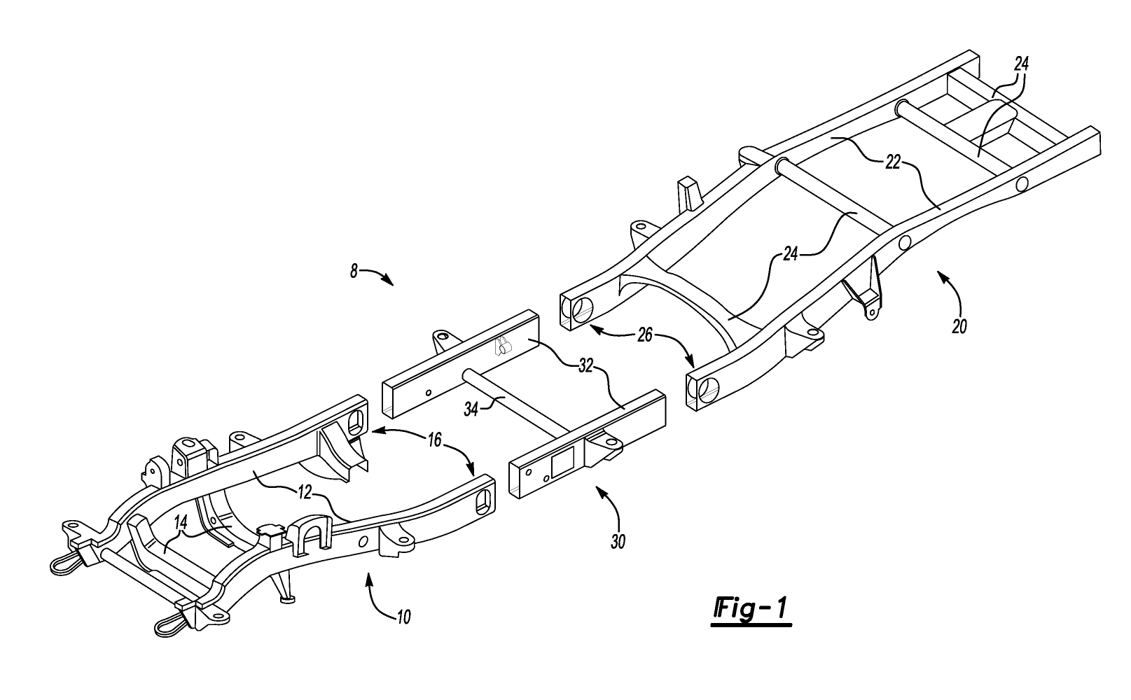

Referring to the drawings, wherein like reference numbers correspond to like or similar components throughout the several figures, there is shown in FIG. 1 an embodiment of a modular body-on-frame architecture 8. Vehicles of different overall body length require different wheelbases and different attachment points for the vehicle body (containing the passenger and cargo compartments). In order to accommodate multiple body lengths, previous body-on-frame designs had to have a unique frame for each wheelbase variation, and a unique frame for each body-type variation. Thus small sport-utility vehicles, small pickup trucks, medium utilities, and medium pickups all had to have unique frames built from unique components. This invention presents a method and assembly allowing each of these body variations (and many others) to be built from shared components, with only slight variations. Note that while FIG. 1 shows only a single set of the components (modules) used to assemble a vehicle frame, the method and assembly described herein envision larger quantities of both frame modules and completed frames. From a limited number of common components, created from shared engineering and tooling resources, multiple platforms can be accommodated by the modular body-on-frame architecture 8.

As used in reference to the drawings, and throughout the specification and appended claims, terms such as “front,” “middle,” and “rear” are used to describe corresponding portions of a vehicle, such as an automobile, as will be recognized by those familiar with automobiles. However, terms such as “left,” “right,” “down,” and “up” are used only descriptively of relative directions in the drawings themselves.

The modular body-on-frame architecture 8 of FIG. 1 is comprised of three frame modules which can be assembled to create a single vehicle frame having a variety of frame lengths. At the front of the vehicle (on the left, as viewed in FIG. 1) is a front module 10. A substantially identical front module 10 is common to all frames made from the modular body-on-frame architecture 8. Front module 10 is generally composed of front longitudinal members 12 transversely spaced by front cross members 14. On the rearward end of each of the front longitudinal members 12 is a front-to-middle frame interface 16.

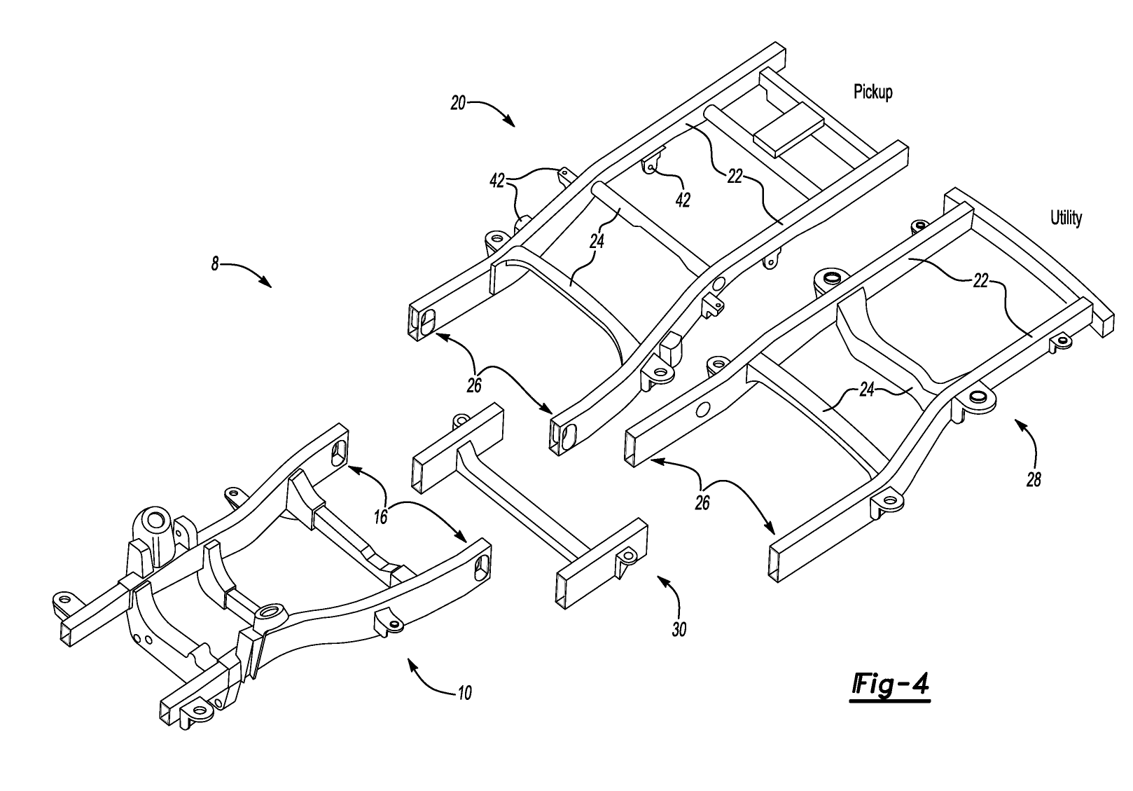

At the rear of the vehicle (on the right, as viewed in FIG. 1) is a rear pickup module 20. One of two rear module variations is common to all frames made from the modular body-on-frame architecture 8; the other variation, a rear sport-utility module 28 will be discussed in more detail below, and is shown in FIG. 4. Rear pickup module 20 is generally composed of rear longitudinal members 22 transversely spaced by rear cross members 24. On the forward end of each of the rear longitudinal members 22 is a rear-to-middle frame interface 26. The front-to-middle frame interface 16 and rear-to-middle frame interface 26 have substantially equal transverse spacing between their respective longitudinal members 12 and 22. The front-to-middle and rear-to-middle frame interfaces 16 and 26 are structures configured to be mated to the middle module 30.

Those having ordinary skill in the art will recognize myriad processes by which frame modules can be manufactured for use in the modular body-on-frame architecture 8. Possible forming methods include, without limitation: roll-forming, stamping, hydroforming, extrusion, or combinations thereof.

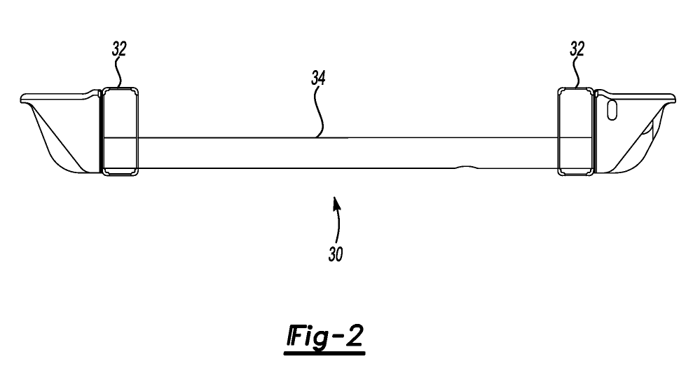

In between the front module 10 and the rear pickup module 20 is the middle module 30. The middle module 30 is generally composed of parallel, constant-section longitudinal rails 32 transversely spaced by a distance substantially equal to the transverse spacing between the frame interfaces 16 and 26. Middle module 30 may be transversely separated by one or more middle cross members 34. “Constant-section” refers to the characteristic that if cut along any plane perpendicular to the constant-section longitudinal rails 32, the rails have a substantially identical profile; i.e. the rails are straight with a uniform cross section. Middle module 30 allows vehicle frames assembled from the modular body-on-frame architecture 8 to achieve variable lengths even though the frames are assembled from common modules. The constant-section longitudinal rails 32 allow the middle module 30 to be produced with a single tool, but still be formable to variable lengths. FIG. 2 shows the middle module 30 from a front view perspective. Viewed from front, the middle module 30 looks substantially the same whether made to a length of 12 inches or 48 inches.

Those having ordinary skill in the art will recognize various methods of creating middle modules 30 of varying lengths with a single tool or die. Possible methods include, without limitation: over-sizing and trimming, roll forming, and short-sheeting. Over-sizing and trimming involves creating multiple longitudinally-oversized modules from a large die, each of which can then be trimmed down to the desired final length. Creating longitudinally-oversized modules, however, may increase costs of the operation by creating waste (from the trimmed-away portions). Roll-forming is a continuous bending operation in which a long strip of metal is passed through consecutive sets of rolls, each performing only an incremental part of the bend, until the desired cross-section profile is obtained. Roll-forming allows modules to be created to substantially final lengths, does so with low amounts of waste, and also offers reduced tooling costs. Both pre-cut and post-cut roll-forming may be suitable for creating middle modules cut to the desired length. Where post-cut roll-forming is used, the roll-formed pieces are cut or trimmed to length at the end of the continuously-feeding process. Short-sheeting involves inserting blanks into the ends of the oversized die to reduce the effective length of the die, and thereby forming a middle module 30 that is essentially the desired length right out of the die. Both roll-forming and short-sheeting result in modules that are pre-sized for specific applications.

Because the constant-section longitudinal rails 32 do not substantially change cross-section throughout the formable or trim-able portion, the interface structures needed to attach to the middle module 30 are the same regardless of the longitudinal length chosen (or the method by which it was created). Therefore, front-to-middle frame interface 16 and rear-to-middle frame interface 26 may be mated to a middle module 30 of any formed or trimmed length.

In order to implement any truly-modular body-on-frame architecture into actual automotive production, significant manufacturer-specific design work must be put into determining the location of the interface structures. Front-to-middle frame interface 16 and rear-to-middle frame interface 26 must be strategically placed to accommodate the many different body types and sizes to which the modular body-on-frame architecture 8 will be applied. Variations in passenger compartments, cargo compartments, engine types and sizes, front and rear suspensions, fuel tanks, and driveline configurations all require that the interface structures 16 and 26—and therefore the formable middle module 30—be placed with great precision. Only with proper placement of the interface structures can multiple platforms be accommodated by a single modular body-on-frame architecture.

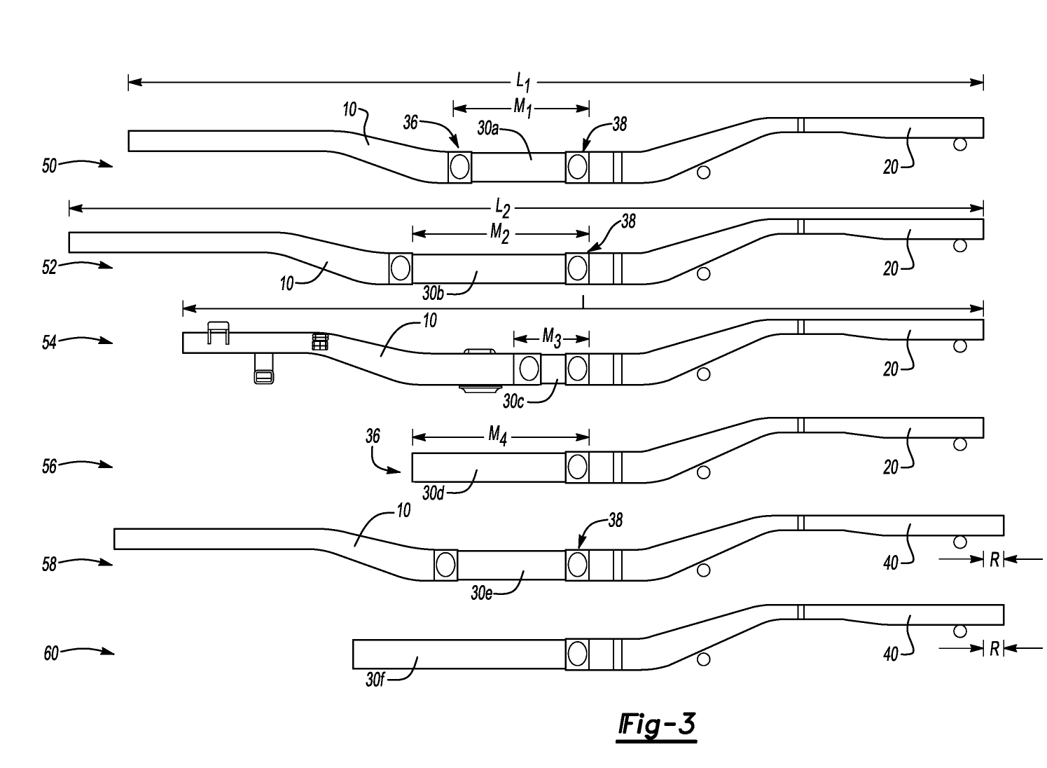

FIG. 3 shows a side view of multiple vehicle frames assembled from the modular body-on-frame architecture 8. To better illustrate the assembly process, some of the frames are shown whole, and some without front modules. The frames of FIG. 3 are assembled using multiple middle modules 30 of varying lengths created with a single tool or die; middle modules 30a, 30b, 30c, 30d, 30e, 30f. The method of assembling vehicle frames from the modular body-on-frame architecture 8 involves first selecting a set of the required components and then assembling the components into the individual frames. A typical first selection of components for a first assembled frame 50 would include selecting a front module 10 from a provided inventory or flow of substantially identical front modules 10, which are common to all assembled frame lengths. Next, either a rear pickup module 20 or a rear sport-utility module 28 would be selected from a provided inventory or flow of one or both of these rear module variations; the specific rear module selected does not alter the method. Selection of the middle module 30a determines the overall length of the assembled frame. Either the pre-sized middle module 30a may be selected, or an oversized middle module 30 may be trimmed to the desired size. As shown in FIG. 3, the first selected middle module 30a has a first longitudinal length M₁.

The first assembled frame 50 is assembled by joining the front-to-middle frame interface 16 to a first end 36 of the middle module 30a, and joining the rear-to-middle frame interface 26 (which is identical on either the rear pickup module 20 or rear sport-utility module 28) to an opposing end 38 of the middle module 30a. The modules can be joined by any method known to those skilled in the art, such as, without limitation: welding, adhesives, fasteners, or another method of bonding. The result is the first assembled frame 50, which has a first frame length L₁.

The method of assembling a second assembled frame 52 is largely identical to the first assembled frame 50. Another, identical, front module 10 and another, identical, rear pickup module 20 are selected from the respective inventories. When a second middle module 30b is selected from the inventory, it is either trimmed to a second longitudinal length M₂, which is different from the first longitudinal length M₁ used in the first assembled frame 50, or a pre-sized middle module having a second longitudinal length M₂ is selected. Because all of the middle modules 30 have constant-section longitudinal rails 32, attachment of the middle module 30b to the front module 10 and rear pickup module 20 is done with a similar process to that used in assembling the first assembled frame 50. After the frame interfaces 16 and 26 are joined to the ends 36 and 38 of the middle module 30b having the second longitudinal length M₂; the result is the second assembled frame 52, which has a second frame length L₂, different from the first frame length L₁.

Third and fourth assembled frames 54 and 56 are similarly assembled using the above described method. Third and fourth frame lengths L₃ and L₄ are achieved by selecting middle modules 30c and 30d with third and fourth longitudinal lengths M₃ and M₄. As shown in FIG. 3 and described above, the common components of the modular body-on-frame architecture 8 shown in FIG. 1 have created four distinct assembled frames having four different frame lengths, L₁, L₂, L₃ and L₄; and can be assembled into innumerable other frame lengths. Each of the components used in the modular body-on-frame architecture 8 is created with shared engineering and tooling solutions while retaining expansive modularity. This ability to create multiple distinct frames from identical components makes the modular body-on-frame architecture 8 capable of achieving substantial manufacturing and production cost savings.

A possible further, and similar, variation in the rear pickup module is shown on fifth and sixth assembled frames 58 and 60, which are assembled using middle modules 30e and 30f, and an extended rear pickup module 40. The extended rear pickup module 40 has a longer overhang, allowing a longer pickup bed to be included on the final vehicle. These extended rear pickup modules 40 are nearly identical to the standard rear pickup modules 20, except that the rear longitudinal members 22 are extended by overhang distance R. This extension R is achieved along the constant-section portion of the rear longitudinal members 22, which allows rear pickup module 20 and extended rear pickup module 40 to be manufactured using the same dies. A single set of dies are tooled to allow for the longest possible rear module length—extended rear pickup module 40—and the die can be short-sheeted to create a module having a smaller standard overhang—the rear pickup module 20.

FIG. 4 shows an embodiment of the modular body-on-frame architecture 8 of FIG. 1, this figure shows both rear module alternatives side by side. In order to accommodate the different body style of sport-utility vehicles, which have integrated passenger and cargo compartments, a preferred embodiment of the modular body-on-frame architecture 8 includes an alternative rear module, the rear sport-utility module 28 mentioned above. As shown in FIG. 4, rear sport-utility module 28 is very similar to rear pickup module 20. Rear sport-utility module 28 is also composed of rear longitudinal members 22 and rear cross members 24, and has the same rear-to-middle frame interface 26. One difference in rear sport-utility module 28 lay in the slightly different paths of the non-constant-section portions of the rear longitudinal members 26, which allow for attachment of the sport-utility body. Alternative rear modules also allow for differences in the rear structure required for different types of suspension.

Even after accommodating such a wide spectrum of wheelbase variations and body types, the need to accommodate multiple suspension types might require further design flexibility. Suspension needs vary widely over the spectrum of small to large utility and pickup truck applications, and may even vary within model lines. Differences in vehicle weight, towing capacity, and desired ride and handling characteristics make it nearly impossible for a single type and size of suspension to be used in all of the myriad vehicles to which the modular body-on-frame architecture 8 may be applied. To overcome this problem, the modular body-on-frame architecture 8 includes a modular bracket set 42 which is configured to be attached to any of the rear modules 20, 28, or 40; and can be attached in multiple locations, creating frame and bracket configurations which allow variation of attachment points for the suspension and other components.

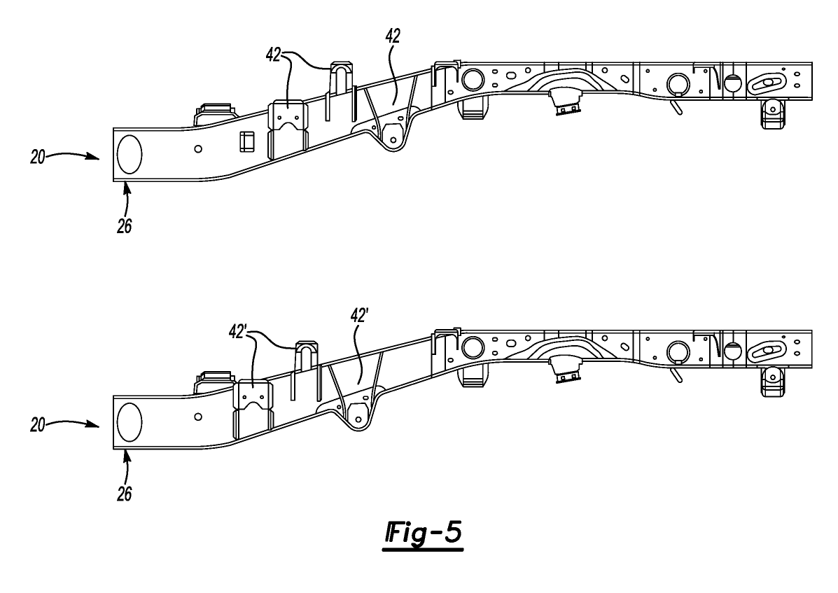

FIG. 5 shows two substantially identical rear pickup modules 20 with different modular bracket set configurations. The upper (as viewed in FIG. 5) pickup module 20 has a first configuration of the modular bracket set 42, and the lower pickup module 20 has a second configuration, denoted 42′. Attachment of the modular bracket set 42 may be accomplished by any method known to those skilled in the art, such as, without limitation: welding, adhesives, fasteners, or another method of bonding.

The frame and bracket configurations created with the modular bracket set 42 add yet another degree of freedom to the modular body-on-frame architecture 8, further expanding the possible range and size of vehicles created using these simple components and method of assembly. From a limited number of common components, created from shared engineering and tooling resources, multiple platforms can be accommodated by the modular body-on-frame architecture 8.

While the best modes for carrying out the invention have been described in detail, those familiar with the art to which this invention relates will recognize various alternative designs and embodiments for practicing the invention within the scope of the appended claims.

1. A method of assembling vehicle frames, comprising:
providing a plurality of substantially identical front modules;
providing a plurality of substantially identical rear modules;
providing a plurality of middle modules having a variety of longitudinal lengths;
selecting a first one of said front modules, a first one of said rear modules, and a first one of said middle modules, wherein said selected first one of said middle modules has a first longitudinal length;
assembling a first vehicle frame from said selected first one of said front modules, said selected first one of said rear modules, and said selected first one of said middle modules, such that said first vehicle frame has a first frame length;
selecting a second one of said front modules, a second one of said rear modules, and a second one of said middle modules, wherein said selected second one of said middle modules has a second longitudinal length different from said first longitudinal length; and
assembling a second vehicle frame from said selected second one of said front modules, said selected second one of said rear modules, and said selected second one of said middle modules, such that said second vehicle frame has a second frame length different from said first frame length.

2. The method of claim 1, further comprising:
providing a plurality of substantially identical modular bracket sets, wherein each of said substantially identical modular bracket sets is configured to be attached to one of said rear modules;
selecting one of said substantially identical modular bracket sets;
mating said selected one of said substantially identical modular bracket sets to said first vehicle frame to form a first frame and bracket configuration;
selecting a third one of said front modules, a third one of said rear modules, and a third one of said middle modules, wherein said selected third one of said middle modules has a third longitudinal length substantially equal to said first longitudinal length; and
assembling a third vehicle frame from said selected third one of said front modules, said selected third one of said rear modules, and said selected third one of said middle modules, such that said third vehicle frame has a third frame length substantially equal to said first frame length;
selecting another of said substantially identical modular bracket sets; and
mating said selected another of said substantially identical modular bracket sets to said third vehicle frame to form a second frame and bracket configuration different from said first frame and bracket configuration.

3. The method of claim 1:
wherein each of said front modules includes a front-to-middle frame interface;
wherein each of said rear modules includes a rear-to-middle frame interface;
wherein said assembling said first vehicle frame includes mating said front-to-middle frame interface of said selected first one of said front modules to a first end of said selected first one of said middle modules, and mating said rear-to-middle frame interface of said selected first one of said rear modules to an opposing end of said selected first one of said middle modules; and
wherein said assembling said second vehicle frame includes mating said front-to-middle frame interface of said selected second one of said front modules to a first end of said selected second one of said middle modules, and mating said rear-to-middle frame interface of said selected second of said rear modules to an opposing end of said selected second one of said middle modules.

4. The method of claim 3, wherein each of said middle modules has a straight, substantially constant-section longitudinal rail portion.

5. The method of claim 3, wherein each of said rear modules further includes an overhang end portion opposite said rear-to-middle frame interface, wherein said overhang end portion is configured to be adjustable to at least two different overhang lengths.

6. The method of claim 1, wherein said plurality of substantially identical rear modules is a set of substantially identical rear pickup modules, further comprising:
providing a set of substantially identical rear sport-utility modules;
selecting another one of said front modules, another one of said middle modules, and one of said rear sport-utility modules; and
assembling another vehicle frame from said selected another one of said front modules, said selected another one of said middle modules, and said selected one of said rear sport-utility modules.

7. A method of assembling vehicle frames, comprising:
providing a plurality of substantially identical front modules;
providing a plurality of substantially identical rear modules;
providing a plurality of middle modules configured to be formable to a variety of desired lengths;
forming a first one of said middle modules to a first longitudinal length;
selecting a first one of said front modules and a first one of said rear modules;
assembling a first vehicle frame from said selected first one of said front modules, said selected first one of said rear modules, and said formed first one of said middle modules, such that said first vehicle frame has a first frame length;
forming a second one of said middle modules to a second longitudinal length different from said first longitudinal length;
selecting a second one of said front modules and a second one of said rear modules; and
assembling a second vehicle frame from said selected second one of said front modules, said selected second one of said rear modules, and said formed second one of said middle modules, such that said second vehicle frame has a second frame length different from said first frame length.

8. The method of claim 7, further comprising:
providing a plurality of substantially identical modular bracket sets, wherein each of said substantially identical modular bracket sets is configured to be attachable to any of said rear modules;
selecting one of said substantially identical modular bracket sets;
mating said selected one of said substantially identical modular bracket sets to said first vehicle frame to form a first frame and bracket configuration;
forming a third one of said middle modules to a third longitudinal length substantially equal to said first longitudinal length;
selecting a third one of said front modules and a third one of said rear modules;
assembling a third vehicle frame from said selected third one of said front modules, said selected third one of said rear modules, and said formed third one of said middle modules, such that said third vehicle frame has a third frame length substantially equal to said first frame length;
selecting another of said substantially identical modular bracket sets; and
mating said selected another of said substantially identical modular bracket set to said third vehicle frame to form a second frame and bracket configuration different from said first frame and bracket configuration.

9. The method of claim 8:
wherein each of said front modules includes a front-to-middle frame interface;
wherein each of said rear modules includes a rear-to-middle frame interface;
wherein said assembling said first vehicle frame includes mating said front-to-middle frame interface of said selected first one of said front modules to a first end of said formed first one of said middle modules, and mating said rear-to-middle frame interface of said selected first one of said rear modules to an opposing end of said formed first one of said middle modules; and
wherein said assembling said second vehicle frame includes mating said front-to-middle frame interface of said selected second one of said front modules to a first end of said formed second one of said middle modules, and mating said rear-to-middle frame interface of said selected second one of said rear modules to an opposing end of said formed second one of said middle modules.

10. The method of claim 9, wherein each of said middle modules has a straight, substantially constant-section longitudinal rail portion.

11. The method of claim 10, wherein each of said rear modules further includes an overhang end portion opposite said rear-to-middle frame interface, wherein said overhang end portion is configured to be adjustable to at least two different overhang lengths.

12. The method of claim 11, wherein said plurality of substantially identical rear modules is a set of substantially identical rear pickup modules, further comprising:
providing a set of substantially identical rear sport-utility modules;
forming another one of said middle modules;
selecting another one of said front modules and one of said rear sport-utility modules; and
assembling another vehicle frame from said selected another one of said front modules, said formed another one of said middle modules, and said selected one of said rear sport-utility modules.

13. Vehicle frame assembly having flexible modular architecture, comprising:
a front frame module having spaced longitudinal front frame members of a predetermined front length and a front structural frame attachment interface spaced by a first transverse distance;
a rear frame module having spaced longitudinal rear frame members of a predetermined rear length and a rear structural frame attachment interface spaced by said first transverse distance;
a mid frame module having parallel straight longitudinal mid frame members spaced by said first transverse distance and a substantially constant cross section, wherein said parallel straight longitudinal mid frame members are configured to be formable to a plurality of mid frame lengths; and
wherein said front structural frame attachment interface is configured to mate to a first end of said parallel straight longitudinal mid frame members of said mid frame module, and wherein said rear structural frame attachment interface is configured to mate to an end opposite said first end of said parallel straight longitudinal mid frame members of said mid frame module.

14. The vehicle frame assembly of claim 13, further comprising a modular bracket set configured to be attachable to said rear frame module in a plurality of bracket locations.

15. The vehicle frame assembly of claim 14, wherein said rear frame module is one of:
a rear pickup frame module, wherein said rear pickup frame module is configured to receive a pickup body and said predetermined rear length is characterized by a first value; and
a rear sport-utility frame module, wherein said rear sport-utility frame module is configured to receive a sport-utility body and said predetermined rear length is characterized by a second value.
